(19) United States
(12) Patent Application Publication
(10) Pub. No.: US 2019/0243172 A1
(43) Pub. Date: Aug. 8, 2019

(54) ILLUMINATING DEVICE, DISPLAY APPARATUS, AND TELEVISION RECEIVER

(71) Applicant: SHARP KABUSHIKI KAISHA, Sakai City (JP)

(72) Inventor: AKIRA GOTOU, Sakai City (JP)

(21) Appl. No.: 16/261,999

(22) Filed: Jan. 30, 2019

(30) Foreign Application Priority Data
Feb. 8, 2018 (JP) 2018-020929

(51) Int. Cl. G02F 1/13357; G02F 1/1335

(52) U.S. Cl. CPC G02F 1/1336; G02F 1/133605; G02F 2001/133614; G02F 1/133606; G02F 1/133603; G02F 1/133608

(57) ABSTRACT

A backlight device includes a light source having such a light distribution that light having peak emission intensity travels in a direction inclined with respect to a front direction, a wavelength conversion sheet that contains a phosphor which converts a wavelength of at least a portion of light from the light source, a reflecting sheet that reflects light, a light source array region where the light source is put, a light source non-array region where the light source is not put, a color presenter that presents a color of light which is identical to the light from the light source or a color of light which is identical to each primary color of light constituting the light, and a high optical absorber that has an optical absorptance which is higher than that of the reflecting sheet.

### BACKGROUND

### 1. Field

The present disclosure relates to an illuminating device, a display apparatus, and a television receiver.

### 2. Description of the Related Art

Japanese Patent No. 5678243 describes an example of a surface illuminating light source device of a conventional liquid crystal display apparatus. The surface illuminating light source device described in Japanese Patent No. 5678243 includes a casing having a bottom surface, a side surface, and an opening of a predetermined area, having a reflector provided inside, and having point light sources disposed on the bottom surface and a radiation-side reflection unit, covering the opening at a predetermined distance from the point light sources, that transmits and reflects light. A central reflector of a predetermined range and a lateral reflector at an outer periphery of the central reflector are provided in a place directly above the point light sources. The lateral reflector is constituted by a reflecting member that transmits, reflects, or diffusely reflects partial light and that has a predetermined reflectance. The central reflector is formed by an optically-transparent reflector having a reflectance which is higher than that of the lateral reflector.

In such a surface illuminating light source device as that described in Japanese Patent No. 5678243, a technique is adopted by which to, by using a reflecting member, make it hard for a bright section where the amount of light is locally large to appear directly above the point light sources. Apart from this, there is a case where a technique is adopted by which, for example, to place a lens that diffuses light directly above the point light sources. In a case where the distance between the liquid crystal panel and the lens is shortened for reduction of the thickness of such a surface illuminating light source device including a lens, optically designing the lens to diffuse light at a wider angle makes it hard for a bright section where the amount of light is locally large to appear directly above the lens. However, such diffusion of light at a wide angle by the lens in turn poses a risk that a bright section where the amount of light is locally large and a dark section where the amount of light locally small may appear around the lens. Especially, in a case where a wavelength conversion sheet is used that converts the wavelength of light of the point light sources, the aforementioned difference in amount of light undesirably appears as color irregularities.

It is desirable to uniform the amount of light that is emitted.

### SUMMARY

According to an aspect of the disclosure, there is provided an illuminating device including an illuminating device including a light source having such a light distribution that light having peak emission intensity travels in a direction inclined with respect to a front direction, a wavelength conversion sheet, placed at a spacing from the light source toward a light exit side in the front direction, that contains a phosphor which converts a wavelength of at least a portion of light from the light source, a reflecting sheet, placed at a spacing from the wavelength conversion sheet toward the light source in the front direction, that reflects light, a light source array region, located on a center side in the wavelength conversion sheet and the reflecting sheet, where the light source is put, a light source non-array region, located on an outer end side in the wavelength conversion sheet and the reflecting sheet, where the light source is not put, a color presenter, disposed to overlap a portion of the light source non-array region in a light exit path through which the light from the light source exits to an outside, that presents a color of light which is identical to the light from the light source or a color of light which is identical to each primary color of light constituting the light, and a high optical absorber, disposed to overlap a portion of the light source non-array region in the light exit path so as to be located closer to the outer end side than the color presenter, that has an optical absorptance which is higher than that of the reflecting sheet.

### BRIEF DESCRIPTION OF THE DRAWINGS

FIG. 1 is an exploded perspective view schematically showing a configuration of a television receiver according to Embodiment 1 of the present disclosure;

FIG. 2 is a cross-sectional view of a liquid crystal display apparatus as taken along line II-II;

FIG. 3 is a plan view of a backlight device of the liquid crystal display apparatus;

FIG. 4 is an enlarged cross-sectional view of an end of the liquid crystal display apparatus in FIG. 2 and an area therearound;

FIG. 5 is an enlarged cross-sectional view of a corner of the backlight device and an area therearound;

FIG. 6 is an enlarged cross-sectional view of an end of a liquid crystal display apparatus according to Embodiment 2 of the present disclosure and an area therearound;

FIG. 7 is an enlarged cross-sectional view of an end of a liquid crystal display apparatus according to Embodiment 3 of the present disclosure and an area therearound;

FIG. 8 is an enlarged cross-sectional view of an end of a liquid crystal display apparatus according to Embodiment 4 of the present disclosure and an area therearound;

FIG. 9 is an enlarged cross-sectional view of an end of a liquid crystal display apparatus according to Embodiment 5 of the present disclosure and an area therearound; and

FIG. 10 is an enlarged cross-sectional view of an end of a liquid crystal display apparatus according to Embodiment 6 of the present disclosure and an area therearound.

### DESCRIPTION OF THE EMBODIMENTS

### Embodiment 1

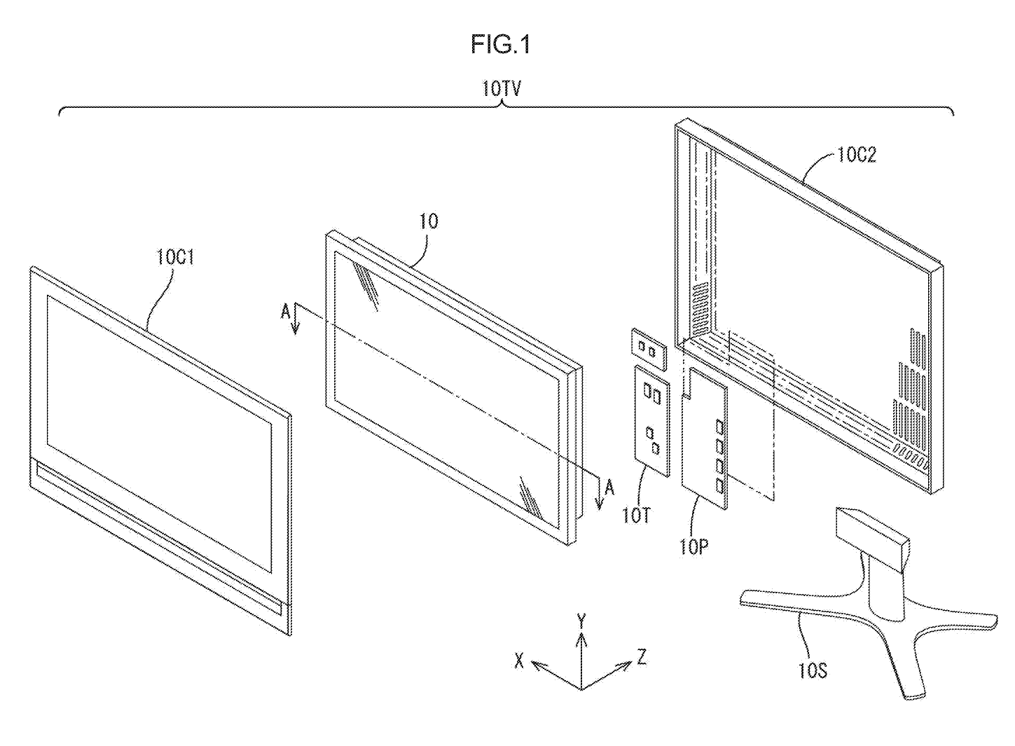

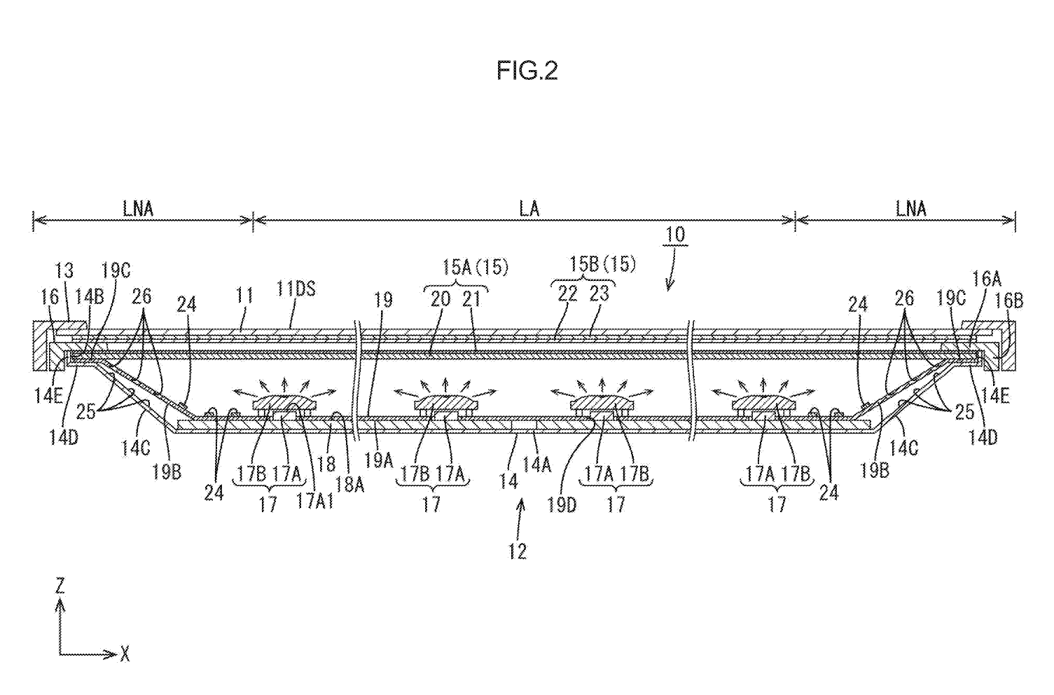

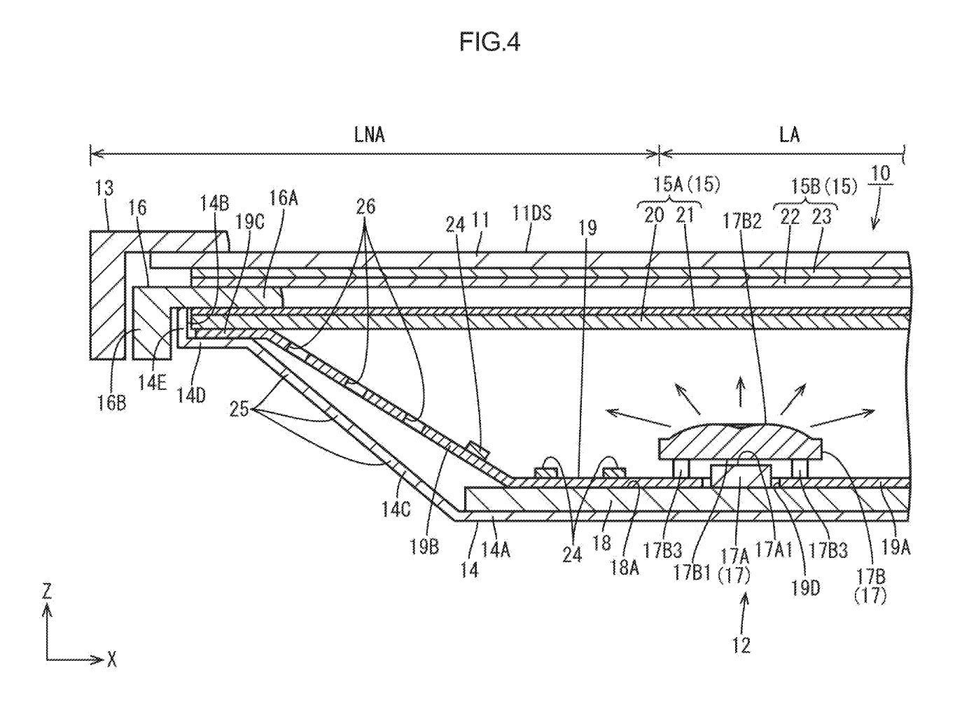

Embodiment 1 of the present disclosure is described with reference to FIGS. 1 to 5. Embodiment 1 illustrates a liquid crystal display apparatus 10. Some of the drawings show an X axis, a Y axis, and a Z axis, and are drawn so that the direction of each axis is an identical direction in each drawing. FIGS. 2 and 4 and the like show the front side up and the back side down.

As shown in FIG. 1, a television receiver 10TV according to Embodiment 1 includes a liquid crystal display apparatus 10 having a horizontally long substantially square shape as a whole, front and back cabinets 10C1 and 10C2 that accommodate the liquid crystal display apparatus 10 in such a manner that the liquid crystal display apparatus 10 is held between the front and back cabinets 10C1 and 10C2, a power source 10P, a tuner (receiver) 10T that receives a television signal, and a stand 103. As shown in FIG. 2, the liquid crystal display apparatus 10 includes a liquid crystal panel (display panel) 11 that displays an image and a backlight device (illuminating device) 12 that supplies the liquid crystal panel 11 with light for display, and the liquid crystal panel 11 and the backlight device 12 are integrally held by a frame-shaped bezel 13.

The following sequentially describes the liquid crystal panel 11 and the backlight device 12, which constitute the liquid crystal display apparatus 10. Among these, as shown in FIG. 1, the liquid crystal panel (display panel) 11 has a horizontally long square shape when seen in a plan view and includes a pair of glass substrates bonded together with a predetermined gap therebetween and liquid crystals sealed in between the glass substrates. One of the glass substrates (array substrate, active matrix substrate) is provided with switching elements (e.g. TFTs) connected to source wires and gate wires that are orthogonal to each other, pixel electrodes connected to the switching elements, an alignment film, and the like, and the other one of the glass substrates (counter substrate, CF substrate) is provided with a color filter having colored portions such as R (red), G (green), and B (blue) portions arranged in a predetermined array, a light shield for preventing mixture of colors among the colored portions, an alignment film, and the like. As shown in FIG. 2, the liquid crystal panel 11 has a display surface 11DS that is capable of displaying an image, and the display surface 11DS has a center side portion serving as a display region where an image is displayed and an outer peripheral side portion serving as a frame-shaped non-display region that surrounds the display region. It should be noted that polarizing plates are disposed on outer sides of the glass substrates, respectively.

As shown in FIG. 2, the backlight device 12 includes a substantially box-shaped chassis 14 with a light exit 14B having an opening facing the front side (light exit side, liquid crystal panel 11 side), an optical member 15 disposed to cover the light exit 14B of the chassis 14, and a frame 16, disposed along the outer edges of the chassis 14 that holds the outer edges of the optical member 15 between the chassis 14 and the frame 15. Furthermore, the chassis 14 houses light sources 17, a light source substrate (LED substrate) 18 on which the light sources 17 are mounted, and a reflecting sheet (reflecting member) 19 that reflects light in the chassis 14. Thus, the backlight device 12 according to Embodiment 1 is or a direct type in which the light sources 17 are disposed in the chassis 14 to be located directly below the liquid crystal panel 11 and the optical member 15. The following describes each of the components of the backlight device 12 in detail.

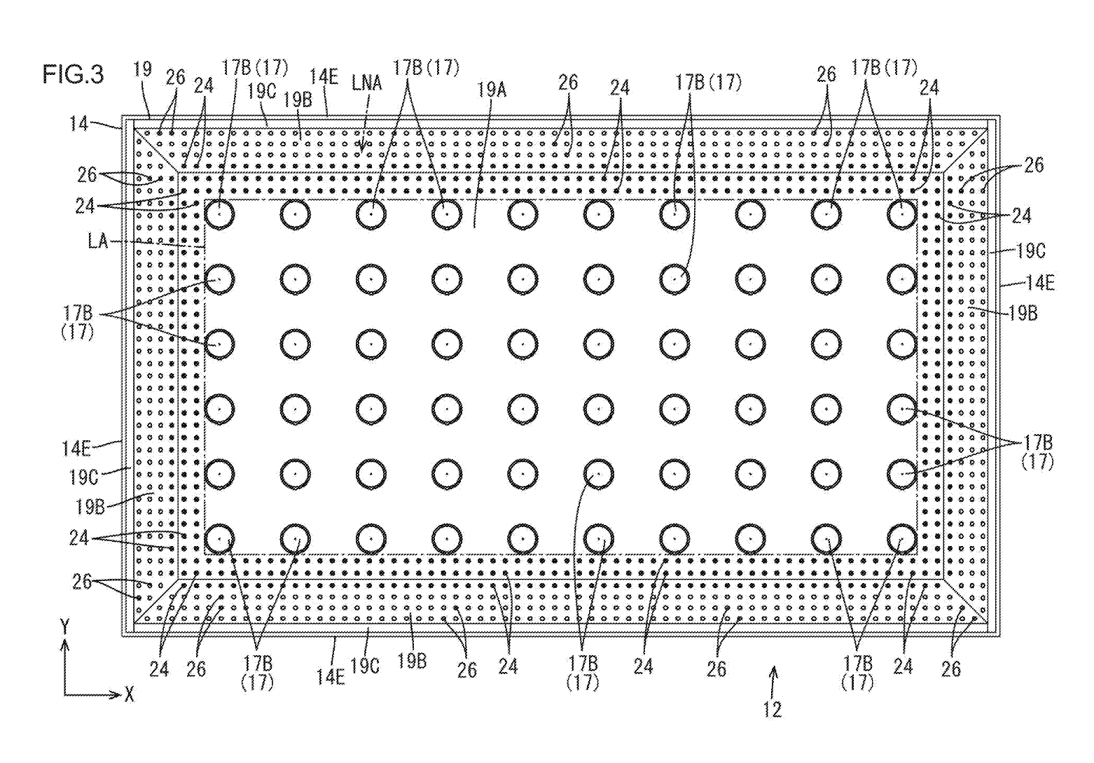

The chassis 14 is constituted by a metal plate such as an aluminum plate or an electro galvanized steel sheet (SECC). As shown in FIGS. 2 and 3, the chassis 14 is constituted by a bottom plate part (bottom part) 14A having a horizontally long square shape (rectangular shape, oblong shape) which is similar to that of the liquid crystal panel 11, side plate parts (side parts) 14C each rising toward the front side (light exit side) from an outer end of a corresponding side (a pair of long sides and a pair of short side) of the bottom plate part 14A, receiving plate parts (optical member supporting parts) 14D each overhanging outward from a rising end of a corresponding one of the side plate parts 14C, and stand plate parts 14E rising from outer ends of the receiving plate parts 14D toward the front side. As a whole, the chassis 14 has a shallow substantially box shape having an opening facing the front side. The chassis 14 has its long side direction corresponding to an X-axis direction and its short side direction corresponding to a Y-axis direction. The bottom plate part 14A is located closer to the back side than the light source substrate 18, i.e. on a side opposite to the light exit side across the light source 17. Each of the side plate parts 14C is inclined with respect to the bottom plate part 14A. Each of the receiving plate parts 14D is capable of supporting outer ends of the optical member 15 and the reflecting sheet 19, which are mounted from the front side. Each of the stand plate parts 14D is joined to an outer end of the bottom plate part 14A via a corresponding one of the side plate parts 14C. Each of the stand plate parts 14E forms an opposed shape with end faces of the optical member 15 and the reflecting sheet 19, which are mounted on a corresponding one of the receiving plate parts 14D, with the after-mentioned frame 16 fixed in each of the stand plate parts 14E.

As with the liquid crystal panel 11 and the chassis 14, the optical member 15 has a horizontally long square shape when seen in a plan view. As shown in FIG. 2, the optical member 15 has its outer ends supported by the receiving plate parts 14D so that the optical member 15 covers the light exit 14B of the chassis 14 and is disposed to be interposed between the liquid crystal panel 11 and the light sources 11. The optical member 15 has an opposed shape with a predetermined spacing toward the front side in a Z-axis direction (front direction), i.e. the light exit side, with respect to the light sources 17. The optical member 15 is composed of a first optical member 15A relatively disposed on the back, side (light sources 17 side, side opposite to the light exit side) and a second optical member 15B relatively disposed on the front side across the frame 16 with respect to the first optical member 15A. The first optical member 15A is mounted in such a manner that its outer ends overlap the front sides of the receiving plate parts 14D of the chassis 14. The first optical member 15A includes a diffusing plate 20 and a wavelength conversion sheet 21. Among these, the diffusing plate 20 includes a substantially transparent resin base material having a predetermined thickness and a large number of diffusing particles diffused in the base material, and has a function of diffusing light that passes through the diffusing plate 20. The wavelength conversion sheet 21 will be again described in detail later.

The second optical member 15B is mounted in such a manner that its outer ends overlap the front side of the frame 16, with a spacing corresponding to the thickness of the frame 16 between the first optical member 15A and the second optical member 15B. The second optical member 15B is composed of a prism sheet (lens sheet) 22 and a reflective polarizing sheet 23 that is put on the front side of the prism sheet 22. The prism sheet 22 is constituted by a sheet-shaped base material and a prism part provided on a front surface of the base material. The prism part is composed of a plurality of unit prisms extending along the long side direction (X-axis direction) and arranged in the short side direction (Y-axis direction). By including such a prism part, the prism sheet 22 can selectively impart a light-gathering effect (anisotropic light-gathering effect) to light from the side of the first optical member ISA in the direction of arrangement (Y-axis direction) of the unit prisms. The reflective polarizing sheet 23 is constituted by a reflecting polarizing film and a pair of diffusing films between which the reflective polarizing film is secured from the front and back. The reflective polarizing film has for example a multilayer structure in which layers differing in refractive index from each other are alternately stacked, transmits P waves of light from the prism sheet 22, and reflects S waves of the light toward the back side. The S waves reflected by the reflective polarizing film are again reflected toward the front side by the after-mentioned reflecting sheet 19 and the like and, in so doing, split into S waves and P waves. By thus including the reflective polarizing film, the reflective polarizing sheet 23 makes it possible to effectively utilize the S waves, which are supposed to be absorbed by the polarizing plates of the liquid crystal panel 11, by reflecting the S waves toward the back side (i.e. toward the reflective sheet 19), thus making it possible to enhance efficiency in the use (luminance) of light. The pair of diffusing films are made of a transparent synthetic resin material such as polycarbonate resin, and each has a surface opposite to the reflective polarizing film subjected to embossing to impart a diffusing effect to light.

The frame 16 is made of synthetic resin, and is painted white to have light reflectivity. As shown in FIG. 2, the frame 16 has a frame shape extending along the outer peripheral edges of the liquid crystal panel 11 and the optical member 15 as a whole. The frame 16 is composed of an inner frame part 16A that forms an opposed shape with each of the receiving plate parts 14D and clamps the outer ends of the first optical member 15A between each of the receiving plate parts 14D and the inner frame part 16A and an outer frame part 16B projecting from outer ends of the inner frame part 16A toward the back side and facing the outer surfaces of the stand plate parts 14E. The inner frame part 16A holds outer ends of the wavelength conversion sheet 21, which constitutes the first optical member 15A, from a side opposite to the receiving plate parts 14D. The inner frame part 16A clamps the outer ends of the liquid crystal panel 11 and the second optical member 15B between the bezel 13 and the inner frame part 16A.

The following describes the light sources 17 and the light source substrate 18, on which the light sources 17 are mounted. As shown in FIG. 2, each of the light sources 17 is composed of an LED (light emitter) 17A that emits light and a lens 17B, facing a light-emitting surface 17A of the LED 17, that diffusely emits light. The LED 17A is a so-called top-emitting (top-view) LED that is surface-mounted on the light source substrate 18, that has its light-emitting surface 17A1 facing away from the light source substrate 18, and that has its optical axis corresponding to the Z-axis direction, i.e. a direction normal (front direction) to the display surface 11DS of the liquid crystal panel 11 (i.e. a plate surface of the optical member 15). The term “optical axis” here refers to an axis that corresponds to the direction of travel of a portion of emitted light from the LED 17A that has the highest (peak) emission intensity. In particular, the LED 17A includes a blue LED element (blue light-emitting element) that emits blue light as a light-emitting source, a case in which the blue LED element is sealed, and a sealant with which the blue LED element is sealed, and the sealant contains a red phosphor (not illustrated) that emits red light upon excitation by the blue light from the blue LED element. Accordingly, the LED 17A is enabled to emit magenta light as a whole through a color mixture of the blue light (blue component of light) emitted by the blue LED element and the red light (red component of light) emitted by the red phosphor upon excitation by the blue light from the blue LED element. Moreover, a portion of the magenta light emitted by the LED 17A is wavelength-converted into green light by the wavelength conversion sheet 21, which will be described in detail later. Accordingly, emitted light from the backlight device 12 presents a color of substantially white through an additive color mixture of the green light obtained through wavelength conversion by the wavelength conversion sheet 21 and the magenta light from the LED 17A. The blue LED element of the LED 17A is a semiconductor made of a semiconductor material such as InGaN and, upon application of a voltage in a forward direction, emits blue monochromatic light of a wavelength included in a blue wavelength region (approximately 120 nm to approximately 500 nm). The blue LED element is connected via a lead frame (not illustrated) to a wiring pattern of the light source substrate 18 disposed outside the case. Further, the red phosphor is excited by the blue light from the blue LED element to emit, as fluorescent light, light of a wavelength region (approximately 600 nm to approximately 780 nm) belonging to red, i.e. red light.

As shown in FIG. 2, the lens 17B, which constitutes the light source 17, is attached to the after-mentioned light source substrate 18 so as to face the light-emitting surface 17A1 of the LED 17A. The lens 17B has a substantially discoid shape that is larger in diameter than the LED 17A, and is concentrically disposed with respect to the LED 17A. The lens 17B has a light entrance surface 17B1 that faces the light-emitting surface 17A1 of the LED 17A and a light exit surface 17B2 that faces the optical member 15. By being formed in a flat substantially semisphericai shape with its center formed in a concave shape, the light-exit surface 17B2 is enabled to emit light while diffusing the light. The light exit surface 17B2 causes the lens 17B to have such a light distribution that light having peak emission intensity travels in a direction inclined with respect to the Z-axis direction. It should be noted that FIGS. 2 and 4 use arrows to indicate the direction of travel and emission intensity of light that is emitted from the light exit surface 17B2, and the longer arrows represent higher emission intensity. Further, the lens 17B has a plurality of attachment legs 17B3 projecting toward the back side, and the attachment legs 17B3 are attached to the light source substrate 18.

As shown in FIGS. 2 and 3, the light source substrate 18 has a square shape when seen in a plan view, and is accommodated in the chassis 14 in such a manner as to overlap the front side of the bottom plate part 14A. The light source substrate 18 has a front plate surface (plate surface that faces the optical member 15) on which the light sources 17 configured as described above are surface-mounted, and it is this plate surface that serves as a mounting surface 18A. A plurality of the light sources 17 are arranged in parallel in rows and columns (i.e. in a matrix or on a grid) along the X-axis direction and the Y-axis direction in a plane of the mounting surface 18A of the light source substrate 18, and are electrically connected to one another by a wiring pattern routed in the plane of the mounting surface 18A. The light sources 17 are placed at substantially regular pitches on the light source substrate 18 and, in particular, placed at substantially regular intervals in the X-axis direction (row-wise direction) and the Y-axis direction (column-wise direction). Further, the light source substrate 18 is made of metal such as the same aluminum material as the chassis 14, has its surface provided with an insulating layer on which a wiring pattern (not illustrated) of a metal film such as copper foil is formed, and has its outermost surface provided with a reflecting layer (not illustrated) that presents a color of white. A usable example of a material of which the light source substrate 18 is made is an insulating material such as ceramics. Further, the light source substrate 18 is provided with a connector to which a wiring member (not illustrated) is connected, so that drive electric power is supplied from an LED drive substrate (light source drive substrate; not illustrated) via the wiring member.

The reflecting sheet 19 is made of synthetic resin and has a surface that presents a color of white, which is excellent in light reflectivity. The reflecting sheet 19 does not absorb light of a particular wavelength through its surface, diffusely reflects all visible light rays, and is substantially constant in reflectance over the whole range of light. As shown in FIGS. 2 and 3, the reflecting sheet 19 has such a size as to be laid over substantially the whole range of an inner surface of the chassis 14.

Therefore, the reflecting sheet 19 is enabled to cover, from the front side (light exit side, optical member 15 side), substantially the whole range of the light source substrate 18 disposed in the chassis 14. The reflecting sheet 19 is placed at a spacing from the optical member 15 (including the wavelength conversion sheet 21) toward the back side (i.e. toward the light sources 17) in the Z-axis direction. The reflecting sheet 19 makes it possible to reflect light in the chassis 14 toward the front side. The reflecting sheet 19 is composed of a reflecting bottom part 19A extending along the light source substrate 18 (bottom plate part 14A) and having such a size as to cover substantially the whole range of the light source substrate 18 en bloc, four reflecting side parts (reflecting inclined side parts) 19B rising from the respective outer ends of the reflecting bottom part 19A toward the front side (i.e. toward the wavelength conversion sheet 211 and inclined with respect to the reflecting bottom part 19A, and extension parts 19C, each extending from an outer edge of a corresponding one of the reflecting side parts 19B, that are placed on the receiving plate parts 14D of the chassis 14. The reflecting bottom part 19A of the reflecting sheet 19 is disposed to overlap the front surface of the light source substrate 18, i.e. the front sides of the light sources 17 with respect to the mounting surface 18A. Further, the reflecting bottom part 19A of the reflecting sheet 19 is provided with light source insertion holes 19D, bored through the reflecting bottom part 19A in positions overlapping the light sources 17 when seen in a plan view, through which the light source 17 are individually inserted. A plurality of the light source insertion holes 19D are arranged side by side in rows and columns (i.e. in a matrix) in the X-axis direction and the Y-axis direction in correspondence with the arrangement of the light sources 17. The inner frame part 16A of the frame 16 has a shape protruding farther inward (toward a light source array region LA) than the extension parts 19C. The extension parts 19C are entirely covered by the inner frame part 16A when seen in a plan view.

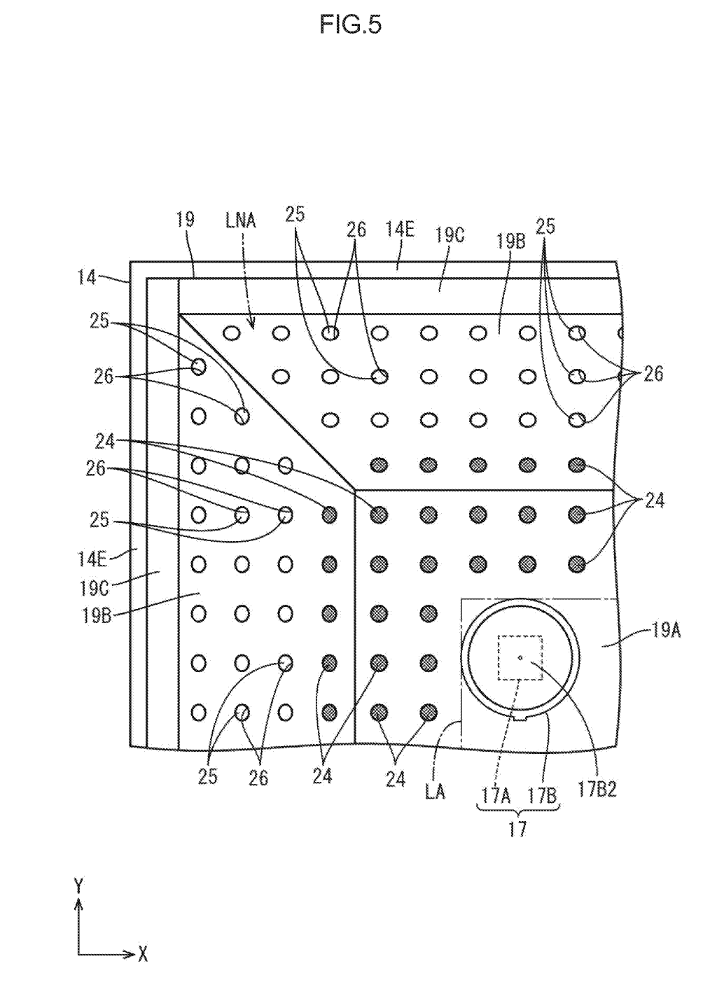

As shown in FIG. 3, the optical member 15 and the reflecting sheet 19 have center side portions in planes thereof serving as a light source array region LA where the plurality of light sources 17 are arranged and outer peripheral end side portions (outer end side portions) serving as a light source non-array region LNA where the plurality of light sources 17 are not arranged. It should be noted that FIGS. 3 and 5 use frame-shaped alternate long and short dash lines to represent the outer shape of the light source array region LA, and the light source non-array region LNA is a region outside the alternate long and short dash lines. The reflecting bottom part 19A of the reflecting sheet 19 is disposed in both the light source array region LA and the light source non-array region LNA, the reflecting side parts 19B of the reflecting sheet 19 are entirely disposed in the light source non-array region LNA. More specifically, the reflecting bottom part 19A has a center side portion serving as the light source array region LA and a frame-shaped outer peripheral end side portion surrounding the light source arran region LA and serving as a center side portion of the light source non-array region LNA. The reflecting side parts 19B serve as outer peripheral end side portions of the light source non-array region LNA disposed farther outside than the center side portion.

Next, the wavelength conversion sheet 21 is described in detail. As shown in FIG. 2, the wavelength conversion sheet 21 has a square shape which is similar to that of the liquid crystal panel 11 or the like, and has substantially the same size as the diffusing plate 20 of the first optical member 15A. The wavelength conversion sheet 21 takes the form of a sheet that is smaller in thickness (thinner) than the diffusing plate 20. The wavelength conversion sheet 21 is composed of a phosphor layer (wavelength conversion layer) containing a phosphor (wavelength conversion substance) for converting the wavelength of light from the light sources 17 and a pair of protective layers that protect the phosphor layer by securing it from the front and back. The phosphor layer is dispersedly blended with a green phosphor that emits green light (in a wavelength region of approximately 500 nm to approximately 570 nm) upon excitation by blue light contained in the magenta light from the light sources 17. This causes emitted light from the backlight device 12 to contain blue light and red light emitted by the light sources 17 and green light obtained through wavelength conversion by the green phosphor contained in the wavelength conversion sheet 21 and become white light as a whole. It is preferable that such a green phosphor be one which has a comparatively sharp emission spectrum, and a usable example of such a green phosphor is a sulfide phosphor such as “SrGa₂S₄:Eu²⁺”.

An optical effect of the optical member 15 (mainly the wavelength conversion sheet 21) is described. First, as shown in FIG. 2, magenta light composed of blue light and red light is emitted as primary light from the light-emitting surface 17A1 of an LED 17A constituting a light source 17, falls on the light exit surface 17B1 of the lens 17B, is given a refractive effect in exiting through the light exit surface 17B2, and exits in such a manner as to diffuse at a wide angle. The primary light from the light source 17 is given a diffusive effect by the diffusing particles contained in the diffusing plate 20, which constitutes the first optical member 15A, and then a portion of the primary light enters the wavelength conversion sheet 21 on the diffusing plate 20. Of the primary light having entered the wavelength conversion sheet 21, a portion of the blue light is released as green light (secondary light) by having its wavelength converted by the green phosphor contained in the wavelength conversion sheet 21. From the wavelength conversion sheet 21, blue light and red light transmitted without having their wavelengths converted are emitted together with the green light. Thus, from the wavelength conversion sheet 21, the primary light (blue light, red light) from the light source 17 and the secondary light (green light) obtained after wavelength conversion are emitted, whereby white light is formed. Emitted light from the wavelength conversion sheet 21 enters the second optical member 15B, is given optical functions by the prism sheet 22 and the reflective polarizing sheet 23, which constitute the second optical member 15B, and exits toward the liquid crystal panel 11.

Incidentally, in the light source array region LA in the backlight device 12 configured as described above, luminance irregularities and color irregularities hardly occur, as an in-plane distribution of the amount of light with which the light source 17 illuminates the wavelength conversion sheet 21 is comparatively uniform. In the light source non-array region LNA, there tend to be irregularities in the in-plane distribution of the amount of light with which the light source 17 illuminates the wavelength conversion sheet 21. Specifically, since the light source 17 has such a light distribution that light having peak emission intensity travels in a direction inclined with respect to the front direction, the amount of light with which the wavelength conversion sheet 21 is illuminated tends to be small on a center side of the light source non-array region LNA that is close to the light source 17 (especially near a boundary between the reflecting bottom part 19A and a reflecting side part 19B in the reflecting sheet 19), whereas the amount of light with which the wavelength conversion sheet 21 is illuminated tends to be large on an outer end side of the light source non-array region LNA that is far away from the light source 17, where luminance irregularities and color irregularities easily occur.

To address this problem, as shown in FIG. 4, the backlight device 12 according to Embodiment 1 has a color presenter 24 and a high optical absorber 25. The color presenter 24 and the high optical absorber 25 are disposed in a light exit path through which the light from the light source 17 exits to the outside. The color presenter 24 and the high optical absorber 25 overlap portions of the light source non-array region LNA, respectively. The color presenter 24 presents a color of light which is identical to the light from the light source 17 or a color of light which is identical to each primary color of light constituting the light. The high optical absorber 25 has an optical absorptance which is higher than that of the reflecting sheet 19. Among these, the color presenter 24 is located closer to the center side than the high optical absorber 25, and the high optical absorber 25 is located closer to the outer end side than the color presenter 24. This makes it possible to compensate for deficiency in the amount of light with the color presenter 24, although the amount of light with which the wavelength conversion sheet 21 is illuminated tends to be small on a center side of the light source non-array region LNA that, is close to the light source 17. This also makes it possible to reduce the excessive amount of light with the high optical absorber 25, although the amount of light with which the wavelength conversion sheet 21 is illuminated tends to be large on an outer end side of the light source non-array region LNA that is far away from the light source 17. For the reason noted above, the in-plane distribution of the amount of light with which the wavelength conversion sheet 21 is illuminated in the light source non-array region LNA is uniformed, so that the amount of light that is emitted too is uniformed and it becomes hard for luminance irregularities or color irregularities to occur. Especially, although the color presenter 24 becomes a factor for reducing in no small measure the efficiency in the use of light, the high optical absorber 25 reduces the amount of light with which the wavelength conversion sheet 21 is illuminated, whereby it is effectively made harder to observe luminance irregularities or color irregularities that are entailed by the reduction in the amount of light due to the color presenter 24.

The color presenter 24 is described in detail. First, as shown in FIGS. 4 and 5, the color presenter 24 is provided on the reflecting sheet 19. Since the reflecting sheet 19 is located closer to the light source 17 in the Z-axis direction than the wavelength conversion sheet 21, the reflecting sheet 19 is more easily fixed in a positional relationship with the light source 17 in the X-axis direction and the Y-axis direction (direction orthogonal to the front direction) than the wavelength conversion sheet 21. Accordingly, providing the color presenter 24 on the reflecting sheet 19 makes it easy for the color presenter 24 to establish a proper positional relationship with the light source 17, suitably reducing luminance irregularities and color irregularities. In comparison with the reflecting sheet 19, the color presenter 24 presents a tint which is close to a tint of light of the light source 17. That is, whereas the reflecting sheet 13 presents a color of white, the color presenter 24 presents a tint of light of the light source 17, i.e. a magenta tint. The color presenter 24 is constituted by a paint film formed by using a publicly-known coating technology (e.g. a printing technology) to apply, to a surface of the reflecting sheet 19, paint (including a pigment or a dye) that presents a color of magenta. The color presenter 24 is higher in absorptance of a color of light (green light) that is complementary to the color of light (magenta light) emitted by the light source 17 than in absorptance of the light (magenta light (blue light, red light)) emitted by the light source 17. Further, the color presenter 24 is higher in reflectance of the light (magenta light (blue light, red light)) emitted by the light source 17 than in reflectance of a color of light (green light) that is complementary to the color of light emitted by the light source 17. That is, the color presenter 24 has a function of absorbing green light and reflecting magenta light (blue light, red light). As a result, light reflected by the color presenter 24 (e.g. white return light) takes on more of a color of magenta than in a case where it is reflected by a white portion (reflecting sheet 19) provided with no color presenter 24.

As shown in FIG. 5, the color presenter 24 takes the form of dots having substantially circular shapes in a plan view, and is provided on both the reflecting bottom part 19A and reflecting side parts 19B of the reflecting sheet 19. A plurality of those color presenters 24 provided on the reflecting bottom part 19A are arranged side by side at intervals along the X-axis direction and the Y-axis direction in a frame-shaped outer peripheral end side portion disposed in the light source non-array region LNA of the reflecting bottom part 19A. In this way, even when the amount of light that is reflected by a portion of the reflecting bottom part 19A that is disposed in the light source non-array region LNA is small, the amount of light that tends to be deficient can be suitably compensated for by the color presenters 24 disposed in that portion. Meanwhile, a plurality of those color presenters 24 provided on the reflecting side parts 193 are arranged side by side at intervals along the X-axis direction or the Y-axis direction in portions of the four reflecting side parts 19B that are close to boundaries with the reflecting bottom part 19A (i.e. to the light source 17). Such a configuration causes the color presenters 24 to be disposed on both the reflecting bottom part 19A and the reflecting side parts 19B across the boundaries between the reflecting bottom part 19A and the reflecting side parts 19B. Since the amount of light from the light source 17 tends to be deficient especially near the boundaries between the reflecting bottom part 19A and the reflecting side parts 19B, the deficiency in the amount of light can be more suitably compensated for by the color presenters 24 disposed across the boundaries. Although the pluralities of color presenters 24 provided on the reflecting bottom part 19A and the reflecting side parts 193 are substantially identical in diameter (size) and density (color density), this is not necessarily intended to impose any limitation. That is, it is also possible to adopt design that makes appropriate changes according to placement to the diameter and density of the color presenters 24 depending on conditions such as the light distribution of the light source 17. It should be noted that a surface of the reflecting sheet 19 that presents a color of white is exposed from a space between adjacent color presenters 24.

Next, the high optical absorber 25 is described in detail. As shown in FIG. 4, the high optical absorber 25 is constituted by portions of the side plate parts 14C, which constitute the chassis 14. In particular, the reflecting side parts 19B, which constitute the reflecting sheet 19, are partially provided with openings 26, and the high optical absorber 25 is constituted by portions of the side plate parts 14 that are illuminated with the light from the light source 17 through the openings 26. Note here that the chassis 14 is made of metal as stated previously and has a surface whose optical reflectance is lower than that of the reflecting sheet 19 and whose optical absorptance is higher than that of the reflecting sheet 19. Accordingly, when light emitted by the light source 17 illuminates the side plate parts 14C of the chassis 14 through the openings 26 partially provided in the reflecting side parts 19B of the reflecting sheet 19, the high optical absorber 25, which is constituted by the portions thus illuminated, absorbs more light than the reflecting sheet 19 and reflects less light than the reflecting sheet 19. This makes it possible to reduce the amount of light that tends to be excessive on an outer end side of the light source non-array region LNA.

As described above, a backlight device (illuminating device) 12 according to Embodiment 1 includes a light source 17 having such a light distribution that light having peak emission intensity travels in a direction inclined with respect to a front direction, a wavelength conversion sheet 21, placed at a spacing from the light source 17 toward a light exit side in the front direction, that contains a phosphor which converts a wavelength of at least a portion of light from the light source 17, a reflecting sheet 19, placed at a spacing from the wavelength conversion sheet 21 toward the light source 17 in the front direction, that reflects light, a light source array region LA, located on a center side in the wavelength conversion sheet 21 and the reflecting sheet 19, where the light source 17 is put, a light source non-array region LNA, located on an outer end side in the wavelength conversion sheet 21 and the reflecting sheet 19, where the light source 17 is not put, a color presenter 24, disposed to overlap a portion of the light source non-array region LNA in a light exit path through which the light from the light source 17 exits to an outside, that presents a color of light which is identical to the light from the light source 17 or a color of light which is identical to each primary color of light constituting the light, and a high optical absorber 25, disposed to overlap a portion of the light source non-array region LNA in the light exit path so as to be located closer to the outer end side than the color presenter 24, that has an optical absorptance which is higher than that of the reflecting sheet 19.

With this, the light emitted by the light source 17 directly illuminates the wavelength conversion sheet 21 or indirectly illuminates the wavelength conversion sheet 21 by being reflected by the reflecting sheet 19, has at least a portion thereof wavelength-converted by the phosphor in passing through the wavelength conversion sheet 21, and is emitted to the outside. Note here that in the light source array region LA, located on the center side in the wavelength conversion sheet 21 and the reflecting sheet 19, where the light source 17 is put, luminance irregularities and color irregularities hardly occur, as an in-plane distribution of the amount of light with which the light source 17 illuminates the wavelength conversion sheet 21 is comparatively uniform. Meanwhile, in the light source non-array region LNA, located on the outer end side in the wavelength conversion sheet 21 and the reflecting sheet 19, where the light source 17 is not put, there tend to be irregularities in the in-plane distribution of the amount of light with which the light source 17 illuminates the wavelength conversion sheet 21. Specifically, since the light source 17 has such a light distribution that light having peak emission intensity travels in a direction inclined with respect to the front direction, the amount of light with which the wavelength conversion sheet 21 is illuminated tends to be small on a center side of the light source non-array region LNA that is close to the light source 17, whereas the amount of light with which the wavelength conversion sheet 21 is illuminated tends to be large on an outer end side of the light source non-array region LNA that is far away from the light source 17, where luminance irregularities and color irregularities easily occur.

To address this problem, in the light exit path through which the light from the light source 17 exits to the outside, the color presenter 21, which presents a color of light which is identical to the light from the light source 17 or a color of light which is identical to each primary color of light constituting the light, and the high optical absorber 25, which has an optical absorptance which is higher than that of the reflecting sheet 19, are disposed to overlap portions of the light source non-array region LNA, respectively. Among these, the color presenter 24 is located closer to the center side than the high optical absorber 25, and the high optical absorber 25 is located closer to the outer end side than the color presenter 24. This makes it possible to compensate for deficiency in the amount of light with the color presenter 24, although the amount of light with which the wavelength conversion sheet 21 is illuminated tends to be small on a center side of the light source non-array region LNA that is close to the light source 17. This also makes it possible to reduce the excessive amount of light with the high optical absorber 25, although the amount of light with which the wavelength conversion sheet 21 is illuminated tends to be large on an outer end side of the light source non-array region LNA that is far away from the light source 17. For the reason noted above, the in-plane distribution of the amount of light with which the wavelength conversion sheet 21 is illuminated in the light source non-array region LNA is uniformed, so that the amount of light that is emitted too is uniformed and it becomes hard for luminance irregularities or color irregularities to occur. Especially, although the color presenter 24 becomes a factor for reducing in no small measure the efficiency in the use of light, the high optical absorber 25 reduces the amount of light with which the wavelength conversion sheet 21 is illuminated, whereby it is effectively made harder to observe luminance irregularities or color irregularities that ace entailed by the reduction in the amount of light due to the color presenter 24.

Further, at least the color presenter 24 may be provided on the reflecting sheet 19. Since the reflecting sheet 19 is located closer to the light source 17 in the front direction than the wavelength conversion sheet 21, the reflecting sheet 19 is more easily fixed in a positional relationship with the light source 17 in a direction orthogonal to the front direction than the wavelength conversion sheet 21. Accordingly, providing at least the color presenter 24 on the reflecting sheet 19 makes it easy for the color presenter 24 to establish a proper positional relationship with the light source 17, suitably reducing luminance irregularities and color irregularities.

Further, the reflecting sheet 19 may have at least a reflecting bottom part 19A disposed in both the light source array region LA and the light source non-array region LNA and a reflecting side part 19B, disposed in the light source non-array region LNA, that rises from the reflecting bottom part 19A toward the wavelength conversion sheet 21, and the color presenter 24 may be provided on at least the reflecting bottom part 19A. In this way, even when the amount of light that is reflected by a portion of the reflecting bottom part 19A that is disposed in the light source non-array region LNA is small, the amount of light that tends to be deficient can be suitably compensated for by the color presenters 24 disposed in that portion.

Further, the color presenter 24 may be provided on the reflecting side part 19B as well as the reflecting bottom part 19A. With this, the color presenter 24 is disposed on both the reflecting bottom part 19A and the reflecting side part 19B across a boundary between the reflecting bottom part 19A and the reflecting side part 19B. Since the amount of light from the light source 17 tends to be deficient especially near the boundary between the reflecting bottom part 19A and the reflecting side part 19B, the deficiency in the amount of light can be more suitably compensated for by the color presenter 24 disposed across the boundary.

Further, the backlight device 12 may further include a chassis 14 having at least a bottom plate part (bottom part) 14A disposed on a side opposite to the light source 17 across the reflecting bottom part 19A and a side plate part (side part) 14C that rises from the bottom plate part 14A toward the wavelength conversion sheet 21. In the backlight device 12, the reflecting side part 19B may be partially provided with openings 26, and the high optical absorber 25 may be constituted by portions of the side plate part 14C that are illuminated with the light from the light source 17 through the openings 26. This allows the chassis 14 to accommodate the light source 17, the reflecting sheet 19, and the like by means of the bottom plate part 14A and the side plate part 14C. The side plate part 14C of the chassis 14 is illuminated with the light from the light source 17 through the openings 26 partially provided in the reflecting side part 19B of the reflecting sheet 19, and the high optical absorber 25 is constituted by portions of the side plate part 14 that are illuminated with the light from the light source 17. As a result, since a portion of the light traveling from the light source 17 toward the reflecting side part 19B of the reflecting sheet 19 is absorbed by the high optical absorber 25 in the side plate part 14C of the chassis 14 through the openings 26, the amount of light that tends to be excessive on an outer end side of the light source non-array region LNA can be reduced.

Further, the reflecting side part 19B may rise from the reflecting bottom part 19A toward the wavelength conversion sheet 21 while being inclined toward the outer end side. This makes it easy for the reflecting side pars 193 disposed in the light source non-array region LNA to reflect light with peak emission intensity traveling from the light source 17 in a direction inclined with respect to the front direction, enabling the reflected light to travel toward the wavelength conversion sheet 21. In comparison with a case where the reflecting side part 19B rises perpendicularly from the reflecting bottom part 19A, light reflected by the reflecting side part 19B illuminates a wider area on the wavelength conversion sheet 21. This more suitably reduces luminance irregularities and color irregularities, as light given an optical effect by at least the high optical absorber 25 illuminates the wavelength conversion sheet 21 while diffusing.

Further, the light source may be composed of an LED (light emitter) 17A that emits light and a lens 17B, facing a light-emitting surface 17A1 of the LED 17A, that emits light from the LED 17 while diffusing the light. This allows the light emitted by the LED 17A to be emitted while being diffused by the lens 17B, thus making it possible to easily design such a light distribution that light having peak emission intensity travels in a direction inclined with respect to the front direction.

Further, the light source 17 may emit magenta light containing blue light and red light, and the wavelength conversion sheet 21 may contain, as the phosphor, a green phosphor that wavelength-converts the blue light into green light. With this, the magenta light emitted by the light source 17 contains the blue light and the red light; therefore, in passing through the wavelength conversion sheet 21, the blue light contained in the magenta light is wavelength-converted into the green light. This causes emitted light from the backlight device 12 to contain blue light, green light, and red light to form white light as a whole.

Further, a liquid crystal display apparatus (display apparatus) 10 according to Embodiment 1 includes the backlight device 12 configured as described above and a liquid crystal panel (display panel) 11 that displays an image by means of light emitted by the backlight device 12. The liquid crystal display apparatus 10 gives high display quality with reduced luminance irregularities and color irregularities, as the amount of light that is emitted by the backlight device 12 is uniform.

Further, a television receiver 10T according to Embodiment 1 includes the liquid crystal apparatus configured as described above. The television receiver 10TV can display a television image with high display quality, as the liquid crystal display apparatus 10 has high display quality.

### Embodiment 2

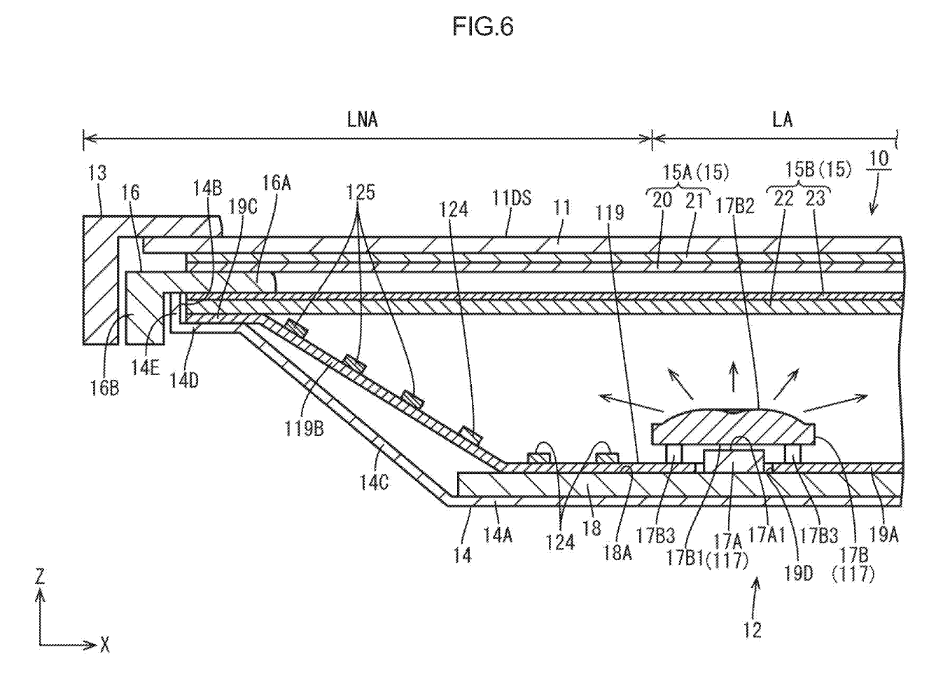

Embodiment 2 of the present disclosure is described with reference to FIG. 6. Embodiment 2 illustrates a change made in a configuration of a high optical absorber 125. It should be noted that a repeated description of structures, actions, and effects which are identical to those of Embodiment 1 described above is omitted.

As shown in FIG. 6, the high optical absorber 125 according to Embodiment 2 is partially provided so as to overlap a front surface (surface facing a light source 117) of a reflecting side part 119B constituting a reflecting sheet 119. The high optical absorber 125 presents a color of black, which is excellent in optical absorbency. Specifically, the high optical absorber 125 is formed, for example, by printing paint (light-absorptive material) such as black ink on the surface of the reflecting side part 119B. The high optical absorber 125 takes the form of dots as with a color presenter 124, and is partially provided on the reflecting side part 119B. In comparison with such a case in Embodiment 1 described above where the openings 26 are partially provided in the reflecting side part 19B (see FIG. 4), the occurrence of leakage of light out of the reflecting sheet 119 can be avoided.

As described above, according to Embodiment 2, the high optical absorber 125 may be partially provided so as to overlap a surface of the reflecting side part 119B that faces the light source 117. With this, in comparison with a case where openings are provided in a reflecting side part, the occurrence of leakage of light out of the reflecting sheet 119 can be avoided.

### Embodiment 3

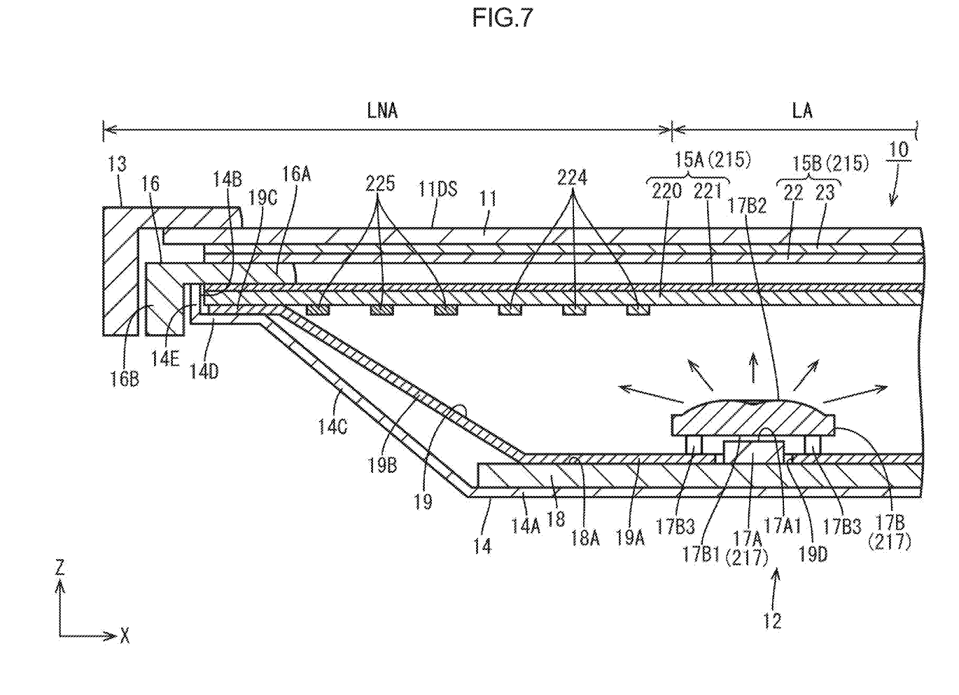

Embodiment 3 of the present disclosure is described with reference to FIG. 7. Embodiment 3 illustrates differences in object of installation of a color presenter 224 and a high optical absorber 225 from those of Embodiment 2 described above. It should be noted that a repeated description of structures, actions, and effects which are identical to those of Embodiment 2 described above is omitted.

As shown in FIG. 7, the color presenter 224 and the high optical absorber 225 according to Embodiment 3 are provided on a diffusing plate 220 included in an optical member 215 and disposed on the back side of a wavelength conversion sheet 221 (that faces a light source 217) in the Z-axis direction. The color presenter 224 and the high optical absorber 225 are provided on a back plate surface of the diffusing plate 220, i.e. a surface of the diffusing plate 220 that faces the light source 217. The color presenter 224 and the high optical absorber 225 are formed by techniques such as printing magenta paint and black paint, respectively, on the back plate surface of the diffusing plate 220.

As described above, according to Embodiment 3, the backlight device 12 may further include a diffusing plate (optical member) 220 disposed on the wavelength conversion sheet 221 in such a manner as to face the light source 217 with respect to the front direction. In the backlight device 12, the color presenter 224 and the high optical absorber 225 may be provided on the diffusing plate 220. With this, the light with which the diffusing plate 220 has been illuminated illuminates the wavelength conversion sheet 221 after having been given optical effects by the color presenter 224 and the high optical absorber 225 provided on the diffusing plate 220.

### Embodiment 4

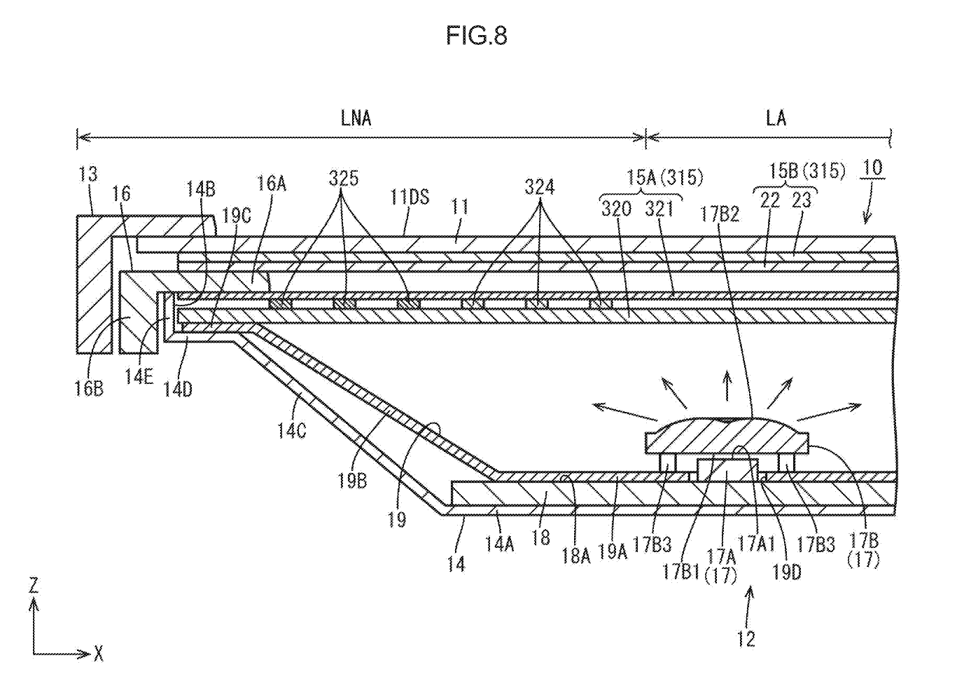

Embodiment 4 of the present disclosure is described with reference to FIG. 8. Embodiment 4 illustrates differences in object of installation of a color presenter 324 and a high optical absorber 325 from those of Embodiment 2 described above. It should be noted that a repeated description of structures, actions, and effects which are identical to those of Embodiment 2 described above is omitted.

As shown in FIG. 8, the color presenter 324 and the high optical absorber 325 according to Embodiment 4 are provided on a wavelength conversion sheet 321 included in an optical member 315. The color presenter 324 and the high optical absorber 325 are provided on a back plate surface of the wavelength conversion sheet 321, i.e. a surface of the wavelength conversion sheet 321 that faces a diffusing plate 320. The color presenter 324 and the high optical absorber 325 are formed by techniques such as printing magenta paint and black paint, respectively, on the back plate surface of the wavelength conversion sheet 321.

As described above, according to Embodiment 4, the color presenter 324 and the high optical absorber 325 may be provided on the wavelength conversion sheet 321. With this, the light with which the wavelength conversion sheet 321 has been illuminated are given optical effects by the color presenter 324 and the high optical absorber 325 provided on the wavelength conversion sheet 321.

### Embodiment 5

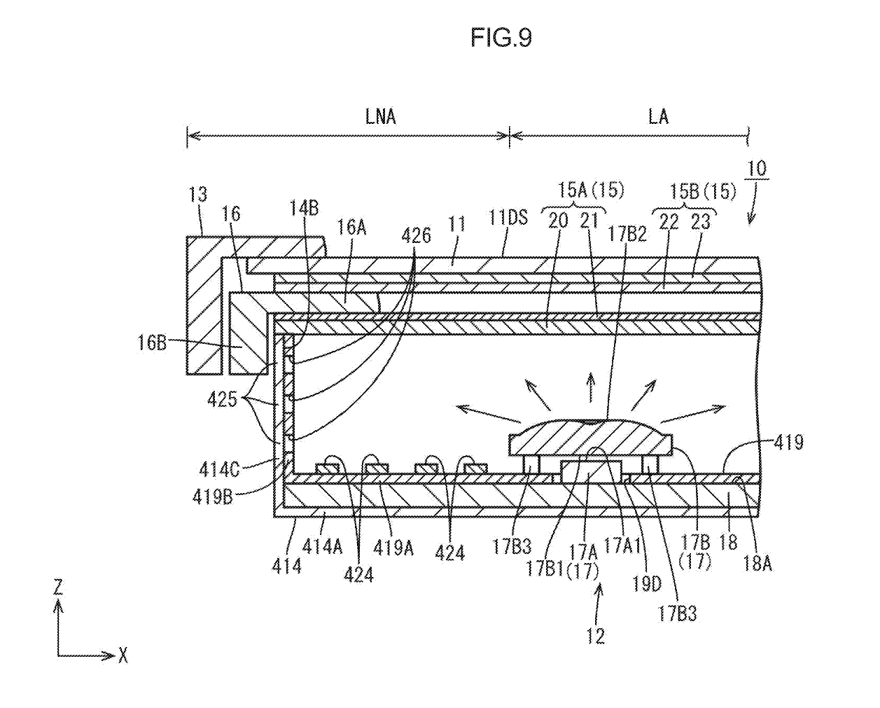

Embodiment 5 of the present disclosure is described with reference to FIG. 9. Embodiment 5 illustrates differences in configuration of a chassis 414 and a reflecting sheet 419 from those of Embodiment 1 described above. It should be noted that a repeated description of structures, actions, and effects which are identical to those of Embodiment 1 described above is omitted.

As shown in FIG. 9, the chassis 414 according to Embodiment 5 is configured such that a side plate part 414C rises substantially perpendicularly from an outer end of a bottom plate part 414A toward the front side. Accordingly, the reflecting sheet 419 is configured such that a reflecting side part 419B rises substantially perpendicularly from an outer end of a reflecting bottom part 419A toward the front side and extends parallel to the side plate part 414C. Therefore, in comparison with Embodiment 1 described above, the bottom plate part 414A and the reflecting bottom part 419A occupy larger areas (ranges of formation) in the light source non-array region LNA, whereas the side plate part 414C and the reflecting side part 419B occupy smaller areas in the light source non-array region LNA. Moreover, a color presenter 424 is provided exclusively on the reflecting bottom part 419A of the reflecting sheet 419, and its range of placement is expanded along with the increase in area of the reflecting bottom part 419A. Meanwhile, openings 426 are provided exclusively in the reflecting side part 419B, and portions of the side plate part 414C that overlap the openings 426 serve as a high optical absorber 425. The range of placement of the openings 426 in the reflecting side part 419B and the range of placement of the high optical absorber 425 in the side place part 414C are reduced along with the decreases in area of the reflecting side part 419B and the side plate part 414C.

### Embodiment 6

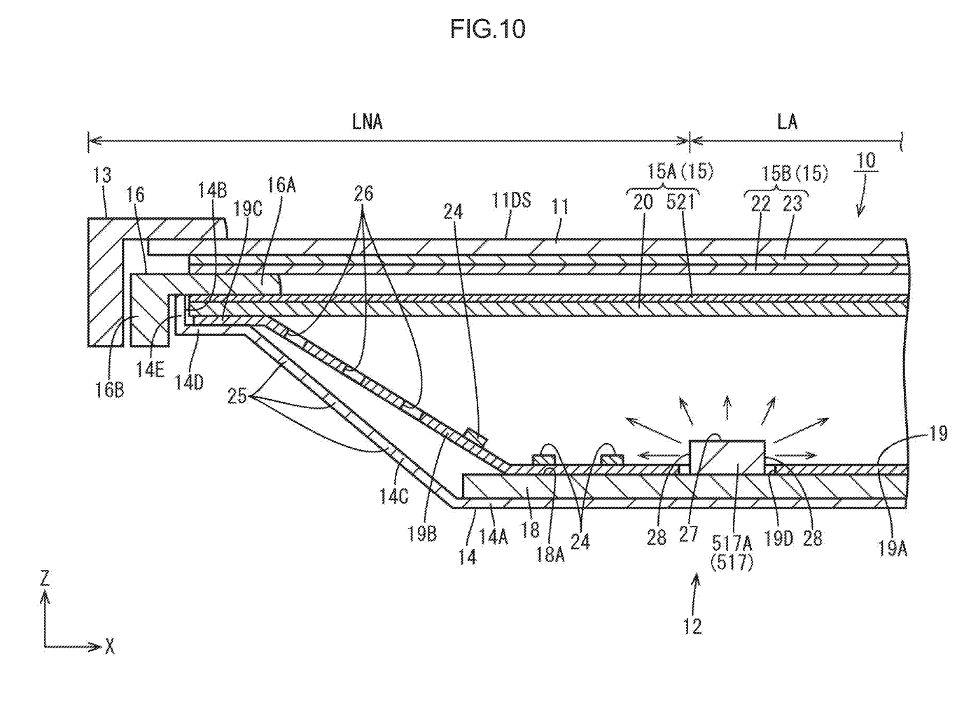

Embodiment 6 of the present disclosure is described with reference to FIG. 10. Embodiment 6 illustrates a difference in configuration of a light source 517 from that of Embodiment 1 described above. It should be noted that a repeated description of structures, actions, and effects which are identical to those of Embodiment 1 described above is omitted.

As shown in FIG. 10, the light source 517 according to Embodiment 6 is constituted solely by an LED 517A with the omission of the lens 17B (see FIG. 4) described in Embodiment 1 described above. The LED 517A has a substantially rectangular parallelepiped shape whose outer peripheral surfaces include a top surface 27 facing the front side (i.e. facing a wavelength conversion sheet 521) and four side surfaces 28 adjacent to the top surface 27, and emits light through the top surface 27 and the side surfaces 28. By making such an adjustment as, for example, to emit a larger amount of light through each of the side surfaces 28 than through the top surface 27, the LED 517A has such a light distribution that light having peak emission intensity travels in a direction inclined with respect to the front direction. It should be noted that FIG. 10 uses arrows to indicate the direction of travel and emission intensity of light that is emitted from the side surfaces 28, and the longer arrows represent higher emission intensity. Such a configuration makes it possible to omit the lens 17B described in Embodiment 1 described above, thus making it possible to reduce the cost of manufacturing the light source 517.

As described above, according to Embodiment 6, the light source 517 may have a top surface 27 forming an opposed shape with the wavelength conversion sheet 521 and side surfaces 28 adjacent to the top surface 27 and emit light through the top surface 27 and the side surfaces 28. With this, light is emitted through the top surface 27 of the light source 517 forming an opposed shape with the wavelength conversion sheet 52L and the side surfaces 28 of the light source 571 adjacent to the top surface 27; therefore, by adjusting the amounts of light that are emitted through the top surface 27 and the side surfaces 28, it is possible to achieve such a light distribution that light having peak emission intensity travels in a direction inclined with respect to the front direction. In comparison with a case where a lens is used separately from the LED 517A that emits light, a reduction in cost is suitably achieved.

### Other Embodiments

The present disclosure is not limited to the embodiments described above with reference to the descriptions and drawings. The following embodiments may be included in the technical scope of the present disclosure.

(1) Although each of the embodiments described above has illustrated a case where the color presenter is selectively provided on any one of the reflecting sheet, the diffusing plate, and the wavelength conversion sheet, the color presenter may be provided on each of more than one of the reflecting sheet, the diffusing plate, and the wavelength conversion sheet.

(2) Although each of the embodiments described above has illustrated a case where the color presenter is selectively provided on any one of the chassis, the reflecting sheet, the diffusing plate, and the wavelength conversion sheet, the color presenter may be provided on each of more than one of the chassis, the reflecting sheet, the diffusing plate, and the wavelength conversion sheet.

(3) Although Embodiments 1, 5, and 6 described above have illustrated a case where portions of a side plate part of the chassis that are illuminated with light from a light source through openings provided in a reflecting side part of the reflecting sheet serve directly as a high optical absorber, it is alternatively possible to enhance the absorbency of light by the high optical absorber, for example, by applying highly optically absorbent paint such as black paint to surfaces of the portions of the side plate part of the chassis that constitute the high optical absorber. In that case, it is also possible to apply the paint to the whole range of an inner surface of the side plate part of the chassis.

(4) Although each of the embodiments (excluding Embodiments 3 and 4) described above has illustrated a case where openings and high optical absorbers are provided in all of the four reflecting side parts that constitute the reflecting sheet, openings and high optical absorbers may be provided in some of the four reflecting side parts and there may be a reflecting side part in which neither openings nor a high optical absorber is formed.

(5) Although not illustrated in any of the embodiments described above, appropriate changes can be made in diameter (size), placement, installation number, planar shape of the color presenters and the high optical absorbers. Examples of the planar shapes of the color presenters and the high optical absorbers include, but are not particularly limited to, polygonal shapes such as quadrangular shapes and triangular shapes, elliptical shapes, and irregular shapes, unless the object of the present disclosure is impaired.

(6) In the case of a modification of each of the embodiments described above where the color presenter and the high optical absorber are constituted by paint, it is possible to change their densities as appropriate, for example, according to placement. It is preferable that these designs be made according to the light distribution of a light source, the number of light sources that are installed, the arrangement of light sources, and the like.

(7) Although each of the embodiments described above has illustrated a color presenter constituted by a paint film, a color presenter may alternatively be constituted, for example, by cellophane of the same color as light emitted by the LED. Mote, however, that the color presenter constituted by a paint film as described in each of the embodiments described above can be formed using an existing painting apparatus (such as a printing apparatus) and, furthermore, is favorably high in rate of formation.

(8) Although each of the embodiments (excluding Embodiments 1, 5, and 6) described above has illustrated a high optical absorber constituted by a paint film, a tape that presents a color of black may alternatively be used as a diffuse reflector. Further, the color that the high optical absorber presents may be changed to an appropriate color other than black.

(9) Although each of the embodiments described above has used a magenta color presenter (of the same color as light emitted by a light source), this is not intended to limit the present disclosure and the color presenter may be of the same color as each primary color of light constituting the light emitted by the light source. For example, in a case where the light from the light source is magenta light (blue light, red light), a combination of a color presenter (blue color presenter) of the same color as the blue light (which is an example of a primary color of light) constituting the magenta light and a color presenter (red color presenter) of the same color as the red light (which is an example of a primary color of light) may be used instead of the magenta color presenter.

(10) Although each or the embodiments described above has used a light source that emits magenta light (blue light, red light), it is alternatively possible, for example to use a light source that emits blue light as primary light and a wavelength conversion sheet containing, as phosphors, a green phosphor that wavelength-converts the blue light into green light and a red phosphor that wavelength-converts the blue light into red light. In this case, the green light and the red light are emitted from the wavelength conversion sheet as secondary light whose wavelength has been converted by the phosphors. The color presenter needs only present the same color of blue as the light source. Further, it is also possible to use for example SrGa₂S₄:Eu²⁺ as the green phosphor and use for example (Ca,Sr,Ba) S: Eu²⁺ as the red phosphor.

(11) Further, in another case, it is possible to use a light source that emits blue light as primary light and use a wavelength conversion sheet containing, as a phosphor, a yellow phosphor that wavelength-converts the blue light into yellow light. In this case, the yellow light is emitted from the wavelength conversion sheet as secondary light whose wavelength has been converted by the phosphor. The color presenter needs only present the same color of blue as the light source.

(12) Further, in another case, it is possible to use a light source that emits purple light and use a wavelength conversion sheet containing a yellow phosphor and a green phosphor as phosphors. In this case, the color presenter needs only present a color of purple.

(13) Further, in another case, it is possible to use a light source that emits cyan light and use a wavelength conversion sheet containing a red phosphor as a phosphor. In this case, the color presenter needs only present a color of cyan.

(14) Although each of the embodiments described above has used a sulfide phosphor as the phosphor of the wavelength conversion sheet, this is not intended to limit the present disclosure and, for example, a quantum dot phosphor may be used. The quantum dot phosphor has a discrete energy level by confining electrons, holes, and exciters in a nanosized semiconductor crystal (e.g. approximately 2 nm to 10 nm in diameter) in a three-dimensional spatial direction, and by changing the size of its dots, the peak wavelength (emission color) of emitted light and the like can be appropriately selected. Since the quantum dot phosphor easily deteriorates in reaction to oxygen or moisture in the air and involves the use of cadmium or the like, which is a substance of concern, it is preferable that the phosphor of the wavelength conversion sheet, be the aforementioned sulfide phosphor. The sulfide phosphor is coated with a silicon dioxide film, and by adding a gas absorbent material into the wavelength conversion sheet, the sulfide phosphor can be said to be high in reliability even in a high-temperature and humidity environment.

(15) Although each of the embodiments described above has illustrated a case where a diffusion plate serving as an optical member is stacked on the back side of a wavelength conversion sheet, an optical member other than a diffusing plate may be stacked on the back side of a wavelength conversion sheet, and in some cases, a color presenter or a high optical absorber may be provided on the optical member.

(16) Although each of the embodiments described above has illustrated a case where the chassis is made of metal, the chassis may be made of synthetic resin.

(17) Although each of the embodiments described above has used an LED as a light emitter of a light source or as a light source, it is also possible to use an organic EL or the like. Further, it is possible to appropriately change the number of light sources that are installed, the arrangement of light sources, and the like. Further, it is also possible to appropriately change the number of light source substrates that are installed and the like.

(18) Although each of the embodiments described above has illustrated the liquid crystal panel and the chassis in landscape orientation where their short sides extend in a vertical direction, the present disclosure also encompasses the liquid crystal panel and the chassis in portrait orientation where their long sides extend in a vertical direction.

(19) Although each of the embodiments described above has used TFTs as the switching elements of the liquid crystal display apparatus, it is also applicable to a liquid crystal display apparatus including switching elements other than TFTs (e.g. thin-film diodes (TFDs)), and is also applicable to a black-and-white liquid crystal display apparatus as well as a color liquid crystal display apparatus.

(20) Although each of the embodiments described above has illustrated a transmissive liquid crystal display apparatus, the present disclosure is alternatively applicable to a reflective liquid crystal display apparatus and a semi-transmissive liquid crystal display apparatus, too.

(21) Although each of the embodiments described above has illustrated a liquid crystal display apparatus including a liquid crystal panel as a display panel, the present disclosure is also applicable to a display apparatus including another type of display panel.

(22) Although each or the embodiments described above has illustrated a television receiver including a tuner, the present disclosure is also applicable to a display apparatus including no tuner. Specifically, the present disclosure is also applicable to a liquid crystal display apparatus that is used as an electronic signboard (digital signage) or an electronic blackboard.

The present disclosure contains subject matter related to that disclosed in Japanese Priority Patent Application JP 2018-020929 filed in the Japan Patent Office on Feb. 8, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An illuminating device comprising:
a light source having such a light distribution that light having peak emission intensity travels in a direction inclined with respect to a front direction;
a wavelength conversion sheet, placed at a spacing from the light source toward a light exit side in the front direction, that contains a phosphor which converts a wavelength of at least a portion of light from the light source;
a reflecting sheet, placed at a spacing from the wavelength conversion sheet toward the light source in the front direction, that reflects light;
a light source array region, located on a center side in the wavelength conversion sheet and the reflecting sheet, where the light source is put;
a light source non-array region, located on an outer end side in the wavelength conversion sheet and the reflecting sheet, where the light source is not put;
a color presenter, disposed to overlap a portion of the light source non-array region in a light exit path through which the light from the light source exits to an outside, that presents a color of light which is identical to the light from the light source or a color of light which is identical to each primary color of light constituting the light; and
a high optical absorber, disposed to overlap a portion of the light source non-array region in the light exit path so as to be located closer to the outer end side than the color presenter, that has an optical absorptance which is higher than that of the reflecting sheet.

2. The illuminating device according to claim 1, wherein at least the color presenter is provided on the reflecting sheet.

3. The illuminating device according to claim 2, wherein the reflecting sheet has at least a reflecting bottom part disposed in both the light source array region and the light source non-array region and a reflecting side part, disposed in the light source non-array region, that rises from the reflecting bottom part toward the wavelength conversion sheet, and
the color presenter is provided on at least the reflecting bottom part.

4. The illuminating device according to claim 3, wherein the color presenter is provided on the reflecting side part as well as the reflecting bottom part.

5. The illuminating device according to claim 3, further comprising a chassis having at least a bottom part disposed on a side opposite to the light source across the reflecting bottom part and a side part that rises from the bottom part toward the wavelength conversion sheet,
wherein the reflecting side part is partially provided with openings, and
the high optical absorber is constituted by portions of the side part that are illuminated with the light from the light source through the openings.

6. The illuminating device according to claim 3, wherein the high optical absorber is partially provided so as to overlap a surface of the reflecting side part that faces the light source.

7. The illuminating device according to claim 5, wherein the reflecting side part rises from the reflecting bottom part toward the wavelength conversion sheet while being inclined toward the outer end side.

8. The illuminating device according to claim 1, further comprising an optical member disposed on the wavelength conversion sheet in such a manner as to face the light source with respect to the front direction,
wherein the color presenter and the high optical absorber are provided on the optical member.

9. The illuminating device according to claim 1, wherein the color presenter and the high optical absorber are provided on the wavelength conversion sheet.

10. The illuminating device according to claim 1, wherein the light source is composed of a light emitter that emits light and a lens, facing a light-emitting surface of the light emitter, that emits light from the light emitter while diffusing the light.

11. The illuminating device according to claim 1, wherein the light source has a top surface forming an opposed shape with the wavelength conversion sheet and side surfaces adjacent to the top surface and emits light through the top surface and the side surfaces.

12. The illuminating device according to claim 1, wherein the light source emits magenta light containing blue light and red light, and
the wavelength conversion sheet contains, as the phosphor, a green phosphor that wavelength-converts the blue light into green light.

13. A display apparatus comprising:
the illuminating device according to claim 1; and
a display panel that displays an image by means of light emitted by the illuminating device.

14. A television receiver comprising the display apparatus according to claim 13.
